(19) United States
(12) Patent Application Publication
(10) Pub. No.: US 2010/0112418 A1
(43) Pub. Date: May 6, 2010

(54) MULTICAPABILITY PRINTED MICROACTUATORS (WITH SPIRAL OR FERROMAGNETIC ACTION) AND FUEL AND OXIDIZER CONTROL DEVICE GROUP

(76) Inventors: Brooke Schumm, JR., Bay Village, OH (US); Brooke Schumm, III, Ellicott City, MD (US)

Correspondence Address: BROOKE SCHUMM III;Daneker, McIntire, Schumm, Prince, Goldstein et al, ONE NORTH CHARLES STREET, SUITE 2450, BALTIMORE, MD, 21201, US

(21) Appl. No.: 11/909,358

(22) PCT Filed: Mar. 21, 2006
(86) PCT No.: PCT/US06/10106

§ 371 Date: Sep. 21, 2007

Related U.S. Application Data
(60) Provisional application No. 60/594,227, filed on Mar. 21, 2005.
(60) Provisional application No. 60/594,225, filed on Mar. 21, 2005.
(60) Provisional application No. 60/596,373, filed on Sep. 20, 2005.

(51) Int. Cl. H01M 2/36; H01M 10/52; H01M 4/82; H01M 2/00

(52) U.S. Cl. 429/57; 429/72; 429/61; 29/623.5

(57) ABSTRACT

The invention proposes resealable, electrically responsive, thermally actuated valves in conjunction with a battery of cells, a case containing a battery, or a cell which valves have certain rotational characteristics that preferably operate spirally and away from an initial plane allowing entry of fluid, and then, on inactivation of a circuit, return to a resting sealed position. A further proposal is to provide the microactuation valve action with a micro ferromagnetic device either printed or otherwise deposited on a substrate to be included in the fuel cell or battery porting system. A further proposal is to increase the current supplying capability of small fuel cells and batteries by providing a metal, semiconductor or polymer barrier membrane containing metal oxides or other advantageous materials to allow increased fuel or oxygen diffusion into the fuel or oxygen depolarized cell or battery.

### CONTINUATION AND PRIORITY DATA

This application claims priority of U.S. Provisional Applications 60/554,227 and 60/554,229 both filed on Mar. 21, 2005, and U.S. Provisional Application 60/596,373 filed on Sep. 20, 2005, and is a continuation-in-part of those applications for countries, including the U.S., where required or allowed.

### FIELD OF THE INVENTION

This invention relates to an electrical appliance and/or fluid depolarized or fueled battery with a valve system operating momentarily, utilizing an efficient microactuator or valve-on-a-chip system placed on the case of an electrical appliance or in or on a sealed battery (including at least one cell) so that the especially adapted valve system operates to allow depolarizing fluid into the battery when desired and only when desired. By using electronic control and/or electromechanical control, this invention reduces the amount of parasitic power consumed by the valve system because the valve system opens the valve and then rests, drawing little or no electrical current. In addition the valve system can be combined with a specially designed diffusion membrane or valve composition (herein described) where the rate of diffusion of fuel or oxidizer to the fuel cell or battery is significantly increased raising the current carrying capability of the fluid fuel and/or depolarized battery or fuel cell.

### SUMMARY OF INVENTION

In contrast to prior semiconductor microactuator art relying on hinges and deformation in linear or multilinear fashion, this invention proposes resealable, electrically responsive, thermally actuated valves in conjunction with a battery of cells, case containing a battery, or cell which valves have certain rotational characteristics that preferably operate spirally and away from an initial plane allowing entry of fluid, and then, on inactivation of a circuit, return to a resting sealed position.

Another microactuating method can be a ferromagnetic linear microactuator device. This element can be used separately or in combination with improved diffusion membranes and valve materials to create fuel cells and air depolarized batteries with greater current supplying capability.

There can also be a spiral or rotational mechanism powering a sealing mechanism either electrically activated and thermally responsive or ferromagnetic.

It is proposed to improve the diffusion of fuel and oxidizer (typically oxygen) into the cell by adding to state of the art (gas permeable) polymer barrier membranes or to other permeable membranes, (metal, semiconductor or polymer), metal oxides such as selected manganese dioxides to affect the pores in these membranes in such a way that fuel and oxidizer transport is increased at a given concentration and pressure of fuel or oxidizer with or without a potential gradient across the membrane.

### BACKGROUND OF INVENTION

Prior art, especially relating to semiconductor microactuator, a “valve-on-a-chip”, after the art of J. H. Jerman, U.S. Pat. No. 5,069,419, Dec. 3, 1991, J. H. Jerman, U.S. Pat. No. 5,271,597, Dec. 21, 1993, or W. America, U.S. Pat. No. 4,969,938, Nov. 13, 1990, and a “Fluister: semiconductor microactuator described in Instruments and Apparatus News [IAN], October 1993, p. 47 and Electronic Design, Nov. 1, 1993 p. 3 (those valves and like valves, including those referenced in that patent, referred to as a “semiconductor actuator valve” or “valve on a chip” or more generally an “electrically activated, thermally responsive microactuator”), had discussed using hinges or irrotational diaphragms in order to accomplish porting.

This invention proposes an improvement over the Jerman art using different port occlusion mechanisms and using those different mechanisms in conjunction with sealing a battery or cell, or a sealed case containing batteries or cells as set forth in art by Brooke Schumm Jr., U.S. Pat. No. 5,304,431, U.S. Pat. No. 5,449,569, U.S. Pat. Nos. 5,541,016 and 5,837,394, and combining concepts in those patents with deposition techniques known in the art, including as referenced in U.S. Provisional Application 60/522,704 filed Oct. 29, 2004 entitled “A Multicapability Microactuator and Fuel and Oxidizer Control Device Group made by Printing and Micromachining for Electrical Apparatus, Especially Small Fuel Cells and Batteries” (the “Schumm Provisional Application”). The descriptions of the formulations of the batteries, cells and casings and permutations and combinations of batteries, cells and casings and disposition of valves and microactuators are adopted by reference from those patents and applications.

One of the principal limitations on the usefulness of small fuel cells and batteries, especially air depolarized fuel cells and batteries, is the limitation in the diffusion rate of oxygen of the air into the cells as noted by Pedicini (U.S. Pat. No. 6,824,915). A limiting characteristic of the cells is often diffusion through one or more otherwise inert porous internal membranes made from materials such as Teflon® from the Dupont Co. typically positioned to keep the electrolyte of the particular fuel cell or battery within and between the active electrodes The use of tiny valves and apertures could increase this diffusion limitation.

### BRIEF DESCRIPTION OF THE DRAWINGS

FIG. 1 is a cross section of an exemplary very small gas depolarized electrochemical cell, a zinc air cell such as for a hearing aid.

FIG. 2 is a cross section of a larger embodiment in the form of a cylindrical or prismatic fluid depolarized cell.

FIG. 3 illustrates a third embodiment where the microvalves are mounted on an airtight non-polarized case.

FIG. 4 illustrates alternative spiral microactuator structures.

FIG. 5 is a circuit diagram which illustrates a potential control circuit, in this instance using an auxiliary power source aside from the fluid depolarized cell.

### OBJECTIVES OF THE INVENTION

An objective of this invention is to create a printed nanoactuator or microactuator with a port that has a sealing mechanism, which upon application of a voltage, functions as a rotating element, namely a spiral, which lifts away from the port and allows the admission of fluid through the spiral and the port, and most importantly, can be produced in industrial volume, which in the instance of batteries, means from the thousands to the millions.

Another alternative object is to use a ferromagnetic element printed as a microactuator, or the spiral to move a shutter or membrane, again producible in industrial volume. Another objective of this invention is to provide another means of valve micro actuation through the provision of a tiny ferromagnetic device, either a microactuator printed or deposited as a flat solenoid or by means of a movable membrane with ferromagnetic properties.

Yet another object of the invention is to provide a multi-layer microvalve assembly for a negative fluid consuming electrode that can have a complex configuration and be efficiently and economically produced at high speeds, preferably using a printing process during at least one step to form the microvalve assembly.

Yet another objective of this invention is to reduce the diffusion limitations of fuel or oxygen into the air depolarized fuel cells or batteries by providing a metal or metal oxide containing membrane in place of or in addition to existing membranes to increase the diffusion rate of fuel into the active negative electrode(s) or oxygen into the positive electrode(s) or to similarly improve the diffusion of fuel or oxygen through the valve structure to the interior containing the active electrodes of the cell.

### DETAILED DESCRIPTION OF PREFERRED EMBODIMENTS

The art in this invention is focused on micromachined valves for regulating fluid flow. In particular, the invention focuses on printing by photolithography, deposition, layering, etching, drilling, perforation for cutting and to enable creation of a separate piece upon electrical activation or to facilitate cutting, and laser cutting techniques and similar nanofabrication and microfabrication techniques collectively referred to as “printing” or “printed.” The term microvalve, valve on a chip, nanoactuator or microactuator are used somewhat interchangeably, but the term microactuator valve system is meant to capture all of those terms and the embodiments of valve systems described in the prior Schumm patents and provisional patents referenced herein by both inventors, and the claims provide further details and/or limitations. Included in the microactuator valve system are electrically activated thermally responsive microactuators and ferromagnetically activated microactuators. The term printed microactuator valve system is simply intended to include microactuator valve systems incorporated into appliances or batteries as the case may be, by one or more of the printing and micromachining techniques referenced. The term battery is intended to include a cell or group of cells. The term electrical appliance includes a case which can be placed in another electrical appliance. As shown by the prior Schumm art, the microactuator valve system, with or without the new art in this invention can be used on an appliance where the system on the appliance controls fluid access to a sealed compartment, or on a case controlled by the appliance which case has the aperture to the battery contained inside in the sealed case, or on a battery itself.

A nanoactuator or microactuator with a port that has a sealing mechanism is created, which upon application of a voltage, functions as a rotating spiral which lifts away from the port and allows the admission of fluid through the spiral and the port. A spiral band is closed upon itself at rest and rests in a plane. Upon application of a voltage, the spiral band spirally and rotationally displaces roughly around a central axis, and displaces away from a port which it formerly covered. Since a spiral is normally thought of as anchored at one end, and unanchored at the other end, which would not enable an electrical connection, the preferred mode is to have the spiral reverse upon itself to a second anchor and electrical connection point. The layout may be the same or analogous to the way a typical electrical stove burner element is laid out which has two points of electrical connection and spirals centrally, but near the center reverses upon itself proceeding to a point adjacent to the point of beginning. In a stove, such a reverse spiral is obviously designed to remain in the same plane and not to substantially expand. The reverse spiral in a stove is separated by an air gap for insulation. In this invention, voltage flows between the first anchor and electrical connection point, and the second anchor and electrical connection point. To accomplish this spiral, we prefer to deposit a resistive material in the desired shape over a substrate with a space left between the resistive material for deposit of insulating material. After deposition of the insulating material, the insulating material would be cut, likely by a laser. The resistive material can have varying amounts of resistive material so that the resistance in the band can vary according to the desired displacement. A port is excised in the substrate beneath this spiral deposition apparatus to allow in the preferred amount of fluid through the gaps in the spiral when it is activated. The port may potentially be improved by having an inner lip included in its configuration.

The achievement of this combination is that upon heating of the resistive material by application of voltage, the resistive material expands and rotates, insulated from adjacent material and rises above the initial plane of deposition, and creates space between emerging coils through which fluid can flow. On cessation of application of voltage, the coil relaxes to its original form and fluid flow is substantially or completely precluded. Most preferably, the design should achieve the cooling off of the center of the spiral where it loops back on itself first, with the remainder cooling less and less rapidly in graduated fashion so that the portion of the reverse spiral most adjacent to the anchor points cools last. A preferred mode is to have the highest resistance and therefore warmest portion adjacent to the anchor points so the spiral opens up closest to the anchor points first. Varying thicknesses of insulation can also be used to affect the timing of the cooling. Additionally, layering of adjacent material with differential coefficients of expansion could be used adjacent to the entire spiral loop, or for parts of the loop to allow for expansion along the planes and to the degree desired.

As a second alternative, the spiral coil with two ends could be created, and then placed over a port and each of the two ends secured to means of applying a voltage, which can include a control circuit.

As a third alternative, the spiral could be anchored with a flexible wire connector and not have the reverse spiral. Using the principles explained, the voltage would be applied between the flexible wire and a first anchor point for the spiral.

As a fourth alternative, the spiral could be designed to engage a catch which is deactivated upon disengagement of the cell from the circuit. In this design, the spiral would have the anchors toward the center of the spiral and the exterior of the spiral would expand above or spread within its original plane or from its original resting position. Control circuitry would detect the engagement of a catch or detente and turn off the voltage to the resistive element, thus reducing parasitic power usage. When the circuit was turned off, the control circuitry would release the catch and the spiral would reset, after perhaps a brief activation or series of short reactivations to minimize friction as the spiral relaxes to its original position.

The overall concept is that when a circuit containing a fluid fueled and/or depolarized battery, particularly a zinc-air cell, is activated, the spiral which would normally be wired in series, expands, admitting depolarizing fluid, especially air, and upon disengagement of the cell, the port is closed by the spiral.

A tiny motion inducing ferromagnetic device is provided by either a microactuator printed or deposited as a flat solenoid or by means of a movable membrane with ferromagnetic properties. The ferromagnetic devices could preferably be made in the following fashion. To create a flat solenoid one creates an inductor structure by printing or otherwise depositing a series of short conductive stripes (a cross pattern such as ////) on an insulating substrate such as a coated metal, plastic or elastomer sheet, then printing or depositing first a parting layer, then a ferromagnetic relatively thick stripe down the center of the diagonal stripes, another parting layer and then printing or depositing another series of short conductive stripes (a cross pattern like \\\\) so as to connect the stripe ends thus creating a continuous conductor in the length direction of the device and then depositing the connection means to the ends of the stripe pattern from the rest of the control circuit. Alternatively the ferromagnetic responding piece could be picked and placed instead of being deposited. It should be longer than the solenoid section and have an attachment point on one or both ends. The so constructed device would then be placed as desired in an electrochemical cell assembly so that upon application of electrical current to the device, the ferromagnetic responding piece will move in a defined path to act as a micro actuator to open or close a port or to move a micro sized grate or other device including latching features as described in the earlier Schumm patents.

To make a moving membrane, the membrane could be a tiny sheet piece such as a chemically inert plastic piece one or more millimeters square or in diameter which would be composed of a suitable plastic matrix and a chosen amount of ferromagnetic particle or wire bits, creating a membrane piece which is attracted by a coil nearby or pushed or pulled by the micro actuator described above thereby opening the cover on a port or opening a passageway into the positive electrode chamber.

As an alternative embodiment, in addition to the already referenced opening of a spiral coil or a rising up out of the resting plane, with and without detents, and with various anchoring mechanisms, an alternative embodiment is to enable more latitude in porting while maintaining the rotational characteristic in conjunction with a shutter, taking advantage of the utility of constructing the valve by known deposition techniques as described in the earlier referenced applications.

More specifically, a nanoactuator or microactuator with a rotationally operated port is created that has a sealing mechanism, which upon application of a voltage, the nanoactuator or microactuator functions as a rotating spiral which can move a sealing mechanism, most likely a shutter, and thus allow the admission of fluid through, or by, the shutter. Such sealing mechanism shall be referred to generically as a shutter, without intending to limit the invention to a shutter. Upon application of a voltage, the spiral band spirally and rotationally displaces roughly around a central axis, and displaces the shutter away from a port which it formerly covered, preferably rotationally on a pivot. There could also be a membrane as already discussed.

The mechanism can be connected physically or electromechanically to the shutter and operated continuously to push a shutter open. This uses a little more parasitic current. Another mode is to use the mechanism to not necessarily couple or connect the mechanism to the shutter but to push the shutter open on actuation of the electrical appliance, and then a second, normally oppositely disposed mechanism, to push the shutter closed on inactivation of the electrical appliance. A detent or catch can be used to secure the shutter in the open position, or detents or catches can be used for both positions. Alternatively, the shutter can be pushed open and left at rest without a detent, and control circuitry can monitor if it remains open and push it open if it accidentally closes due to a shock to the valve or the device in which it is disposed. A second mechanism would be used to push the shutter back.

Since a spiral is normally thought of as anchored at one end, and unanchored at the other end, which would not enable an electrical connection, but could have a wire to make that electrical connection. The preferred mode is to have the spiral reverse upon itself to a second anchor and electrical connection point. The layout may be the same or analogous to the way a typical electrical stove burner element is laid out which has two points of electrical connection and spirals centrally, but near the center reverses upon itself proceeding to a point adjacent to the point of beginning. In a stove, such a reverse spiral is obviously designed to remain in the same plane and not to substantially expand. The reverse spiral in a stove is separated by an air gap for insulation.

In this invention, voltage flows between the first anchor and electrical connection point, and the second anchor and electrical connection point. To accomplish this spiral, it is preferable to deposit a resistive material over a substrate in the desired shape with a space left between the resistive material for deposit of insulating material. After deposition of the insulating material, the insulating material would be cut, likely by a laser. The resistive material can have varying amounts or composition of resistive material so that the resistance in the band can vary according to the desired displacement. The shutter would be deposited as a layer over a parting layer so that upon either a physical process, or initial activation of the mechanism, the shutter would be broken away from the parting layer and would be useable. One or more ports are excised in the substrate and parting layer beneath this deposited shutter apparatus to allow in the preferred amount of fluid through the ports in the shutter when it is activated. A photolithography process may be used for at least part of the process of creation of the valve and movement mechanism. Alternatively, the shutter could be physically placed in combination with deposition of remaining parts.

The achievement of this combination is that upon heating of the resistive material by application of voltage, the resistive material expands and rotates, insulated from adjacent material and activates the shutter.

In the first mode of being physically or electromechanically coupled to the shutter, the shutter is held open. On cessation of application of voltage, the coil or spiral relaxes to its original form and fluid flow is substantially or completely precluded. Most preferably, the design should achieve the cooling off of the center of the spiral where it loops back on itself first, with the remainder cooling less and less rapidly in graduated fashion so that the portion of the reverse spiral most adjacent to the anchor points cools last. A preferred mode is to have the highest resistance and therefore warmest portion adjacent to the anchor points so the spiral, partial spiral or coil opens up closest to the anchor points first. Varying thicknesses of insulation can also be used to affect the timing of the cooling. Additionally, layering of adjacent material with differential coefficients of expansion could be used adjacent to the entire spiral loop, or for parts of the loop to allow for expansion along the planes and to the degree desired.

As another alternative, the spiral could be anchored with a flexible wire connector and not have the reverse spiral. Using the principles explained, the voltage would be applied between the flexible wire and a first anchor point for the spiral. Alternatively, the spiral, partial spiral or coil with two ends could be created, and then placed to operate the shutter and each of the two ends secured to means of applying a voltage, which can include a control circuit.

In the second mode of a push pull mechanism on a pivoting shutter which mechanism and deposit have been deposited, the spiral, partial spiral or coil would be used to bend rotationally acting on the shutter so as to move it to a desired position. A detent, or control circuit to restore position, would be used to insure the shutter stays open. Control circuitry would detect the engagement and turn off the voltage to the resistive element, to reduce parasitic usage. When the circuit was turned off, the control circuitry would release the catch and the spiral would reset, including after perhaps a brief activation or series of short reactivations to minimize friction as the spiral relaxes to its original position.
The mechanism described herein can be set up upon an electrical appliance case, or on a battery or on individual cells in a battery.

The diffusion of oxygen into the cell is improved by adding to the case appliance or battery state of the art (gas permeable) polymer barrier membranes or to other permeable membranes, (metal, semiconductor or polymer), metal oxides such as selected manganese dioxides to affect the pores in these membranes in such a way that oxygen transport is increased at a given concentration and pressure of oxygen with or without a potential gradient in the membrane. Suitable manganese dioxides can be obtained from ERACHEM of Belgium and Baltimore, Md. or Kerr McGee Corp of the U.S.A. or TOSO Corp of Japan. A preferred type would be Erachem high porosity, high purity manganese dioxide for electrochemical cells. The preferable manganese dioxides will have a high surface area, preferably 80 to 100 square meters per gram and as small as nanometer sized particles. Commercial purity is believed to be adequate if the membrane is on the non-active side of the positive or negative electrode. The manganese dioxide could be blended into the polymer before coating or extrusion where porosity is formed thus exposing at least a part of the manganese dioxide created in typical industrial processes such as practiced by Celgard, Inc.™ for polypropylene membranes, or it could be washed into and onto a membrane with existing pores with either a solvent or aqueous slurry. The treated membrane would be cut and placed in the battery or cell of interest during the assembly process. Similarly a slurry with suitable solvent and polymer or elastomer binding agent could be coated or printed onto a porous membrane already in use in a cell design. Most generally, the concept is a membrane with metal, metal oxides or porous polymers having oxide or hydroxyl molecules on the surface of the pore structure.

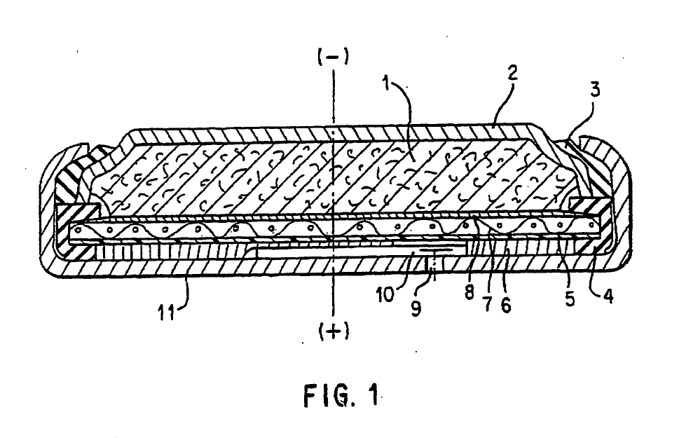

A printed fluid regulating microvalve is built up in layers at least one of which is printed where the microvalve will control the supply of fluids such as hydrogen (gas) or methanol (liquid) to the negative electrode. If a diffusion membrane was utilized in conjunction with regulating fluid flow to the negative electrode, preferred materials could include palladium, finely divided iron, or metal oxides. The figures illustrate the above principles. FIG. 1 shows an exemplary very small gas depolarized electrochemical cell, such as for a hearing aid, which is comprised of a zinc anode mixture (1) disposed adjacent to and in electrical contact with a cover (2). This is shown in FIG. 1 as being flat but which can be any shape and which is negatively charged in this embodiment. The zinc anode mixture is one of the electrodes of the cell. A container (11) corresponding in shape to the shape of the cover (2) (which cover is positively charged as the positive oxygen electrode in this example) surrounds a gasket (3) disposed on the inside edge of the container (11), both of which surround the cover (2), so that the gasket (3) seals that part of the cell and separates the negatively polarized cover from the positively polarized container (11). Another gasket (4) is disposed on the inside corner of the container (11) to locally isolate the active positive electrode (7) from the inside of the container (11) so that electrical output is forced to pass through the series-connected microvalve which is mounted in this example inside the cavity (10) of the container (11), the active cathode (7) being a porous cathode layer with a conductive metal mesh or screen or the equivalent in it and being one of the electrodes of the cell. Gasket (4) also holds in place the cell separator (8), the cathode layer (7) and a porous electrolyte proof membrane (5) which evens diffusion to the active positive electrode and is made of a material such as Teflon (Dupont Trademark) and a diffusion pad (6) with a space in it to accommodate one or more microvalves (10) controlling air access through port (9) so that the sole means of fluid (e.g. air) entry to the cell is through the port and by the microvalve.

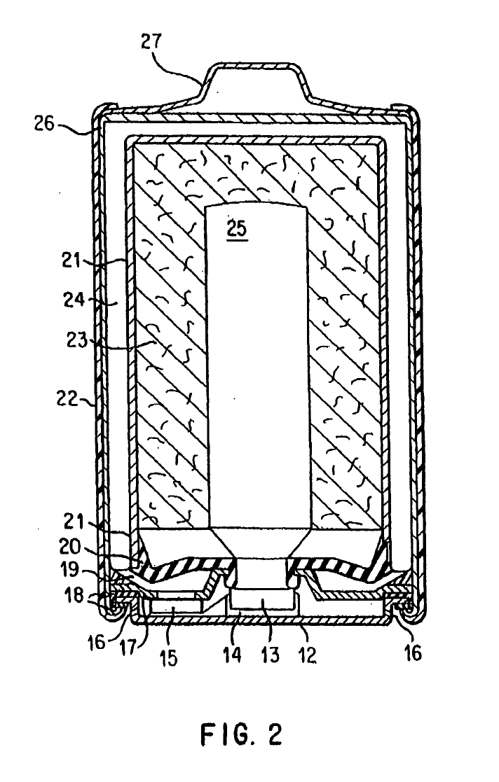

FIG. 2 is a larger preferred embodiment of a cylindrical or prismatic cell where the microvalve functions as in FIG. 1 but with a similar anode mixture (23) and active air assisted cathode mixture (24). Microvalve (15) controls the entry of air from port (16) through the microvalve body into the positive electrode chamber (defined by structural bracing member (17), container (26), seal member (20), and cell separator (21)).

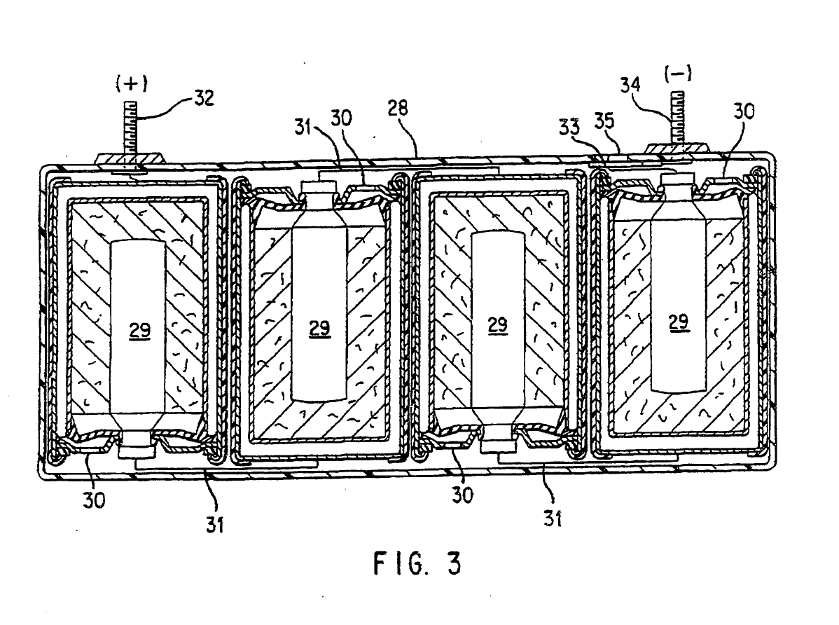

FIG. 3 illustrates a third embodiment where the microvalves are mounted on an airtight non-polarized case. One or more microvalves (33) powered by the cells inside the case (or a separate one or more cells) completely control air access to the inside of the case and hence to the cells contained therein.

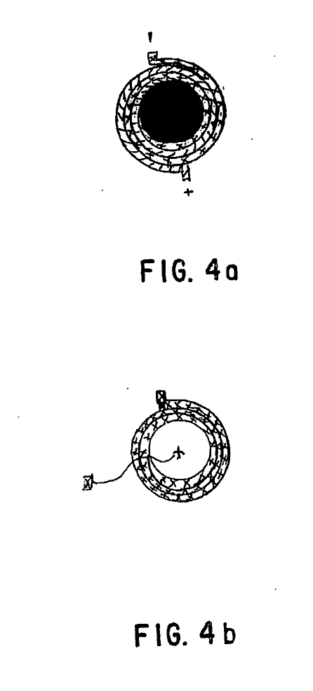

FIG. 4 illustrates alternative spiral microactuator structures. They can be embodied to preclude fluid flow through an aperture or port without any additional parts, and simply expand away from their resting position upon application of electrical power through the resistance material making up the spiral.

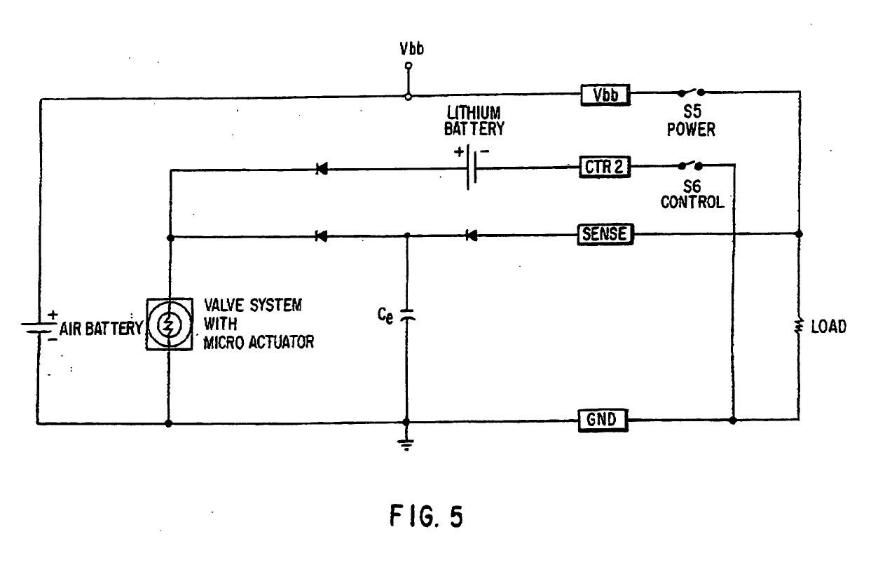

FIG. 5 is a circuit diagram which illustrates a potential control circuit, in this instance using an auxiliary power source aside from the fluid depolarized cell.

The embodiments represented herein are only a few of the many embodiments and modifications that a practitioner reasonably skilled in the art could make or use. The invention is not limited to these embodiments.

Alternative embodiments and modifications which would still be encompassed by the invention may be made by those skilled in the art, particularly in light of the foregoing teachings. Therefore, the following claims are intended to cover any alternative embodiments, modifications or equivalents which may be included within the spirit and scope of the invention as claimed.

1. An improved electrical appliance having at least one battery comprising:
at least one printed microactuator valve system;
said at least one printed microactuator valve system having at least one ferromagnetic actuating element;
at least one aperture associated with said at least one printed microactuator valve system to admit fluid to the interior of said at least one battery through said at least one aperture while said appliance is operating;
said at least one microactuator valve system being disposed to occlude admission of fluid to the interior of said battery through said at least one aperture associated with said at least one printed microactuator valve system while said appliance is not operating;
said at least one printed microactuator valve system having at least one ferromagnetic actuating element being disposed so that upon operation of said electrical appliance, said at least one ferromagnetic actuating element causes said at least one microactuator valve system to admit fluid to the interior of said battery through at least one aperture associated with said at least one microactuator valve system while said appliance is operating.

2. A battery for powering an electrical appliance comprising:
at least one printed microactuator valve system;
said at least one printed microactuator valve system having at least one ferromagnetic actuating element;
at least one aperture associated with said at least one printed microactuator valve system to admit fluid to the interior of said battery through said at least one aperture when an electrical appliance powered by said battery is turned on;
said at least one microactuator valve system being disposed to occlude admission of fluid to the interior of said battery through said at least one aperture associated with said at least one printed microactuator valve system while said appliance is not operating;
said at least one printed microactuator valve system having at least one ferromagnetic actuating element being disposed so that upon operation of said electrical appliance, said at least one ferromagnetic actuating element causes said at least one microactuator valve system to admit fluid to the interior of said battery through at least one aperture associated with said at least one microactuator valve system while said appliance is operating.

3. An improved electrical appliance having at least one battery comprising:
at least one microactuator valve system;
said at least one microactuator valve system having at least one diffusion layer having an oxygen diffusion enhancing compound;
at least one aperture associated with said at least one microactuator valve system to admit fluid to the interior of said at least one battery through said at least one aperture while said appliance is operating;
said at least one microactuator valve system being disposed to occlude admission of fluid to the interior of said battery through said at least one aperture associated with said at least one microactuator valve system while said appliance is not operating;
said at least one microactuator valve system being disposed so that upon operation of said electrical appliance, fluid is admitted to the interior of said battery through at least one diffusion layer and at least one aperture associated with said at least one microactuator valve system while said appliance is operating.

4. The electrical appliance according to claim 3, further comprising:
said microactuator valve system being printed on said electrical appliance.

5. A battery for powering an electrical appliance further comprising:
at least one microactuator valve system;
said at least one microactuator valve system having at least one diffusion layer having an oxygen diffusion enhancing compound;
at least one aperture associated with said at least one microactuator valve system to admit fluid to the interior of said battery through said at least one aperture when an electrical appliance powered by said battery is turned on;
said at least one microactuator valve system being disposed to occlude admission of fluid to the interior of said battery through said at least one aperture associated with said at least one microactuator valve system while said appliance is not operating;
said at least one microactuator valve system being disposed so that upon operation of said electrical appliance, fluid is admitted to the interior of said battery through at least one diffusion layer and at least one aperture associated with said at least one microactuator valve system while said appliance is operating.

6. The battery according to claim 5, further comprising:
said microactuator valve system being printed on said battery.

7. An improved electrical appliance having at least one battery comprising:
at least one microactuator valve system having at least one rotational actuating element;
at least one aperture associated with said at least one microactuator valve system to admit fluid to the interior of said at least one battery through said at least one aperture while said appliance is operating;
said at least one microactuator valve system being disposed to occlude admission of fluid to the interior of said battery through said at least one aperture associated with said at least one printed microactuator valve system while said appliance is not operating;
said at least one printed microactuator valve system having at least one rotational actuating element being disposed so that upon operation of said electrical appliance, said at least one rotational actuating element causes said at least one microactuator valve system to admit fluid to the interior of said battery through at least one aperture associated with said at least one microactuator valve system while said appliance is operating.

8. A battery for powering an electrical appliance comprising:
at least one microactuator valve system having at least one rotational actuating element;
at least one aperture associated with said at least one microactuator valve system to admit fluid to the interior of said battery through said at least one aperture when an electrical appliance powered by said battery is turned on;
said at least one microactuator valve system being disposed to occlude admission of fluid to the interior of said battery through said at least one aperture associated with said at least one microactuator valve system while said appliance is not operating;
said at least one microactuator valve system having at least one rotational actuating element being disposed so that upon operation of said electrical appliance, said at least one rotational actuating element causes said at least one microactuator valve system to admit fluid to the interior of said battery through at least one aperture associated with said at least one microactuator valve system while said appliance is operating.

9. An improved electrical appliance having at least one battery comprising:
at least one printed microactuator valve system having at least one rotational actuating element;
at least one aperture associated with said at least one printed microactuator valve system to admit fluid to the interior of said at least one battery through said at least one aperture while said appliance is operating;
said at least one printed microactuator valve system being disposed to occlude admission of fluid to the interior of said battery through said at least one aperture associated with said at least one printed microactuator valve system while said appliance is not operating;
said at least one printed microactuator valve system having at least one rotational actuating element being disposed so that upon operation of said electrical appliance, said at least one rotational actuating element causes said at least one printed microactuator valve system to admit fluid to the interior of said battery through at least one aperture associated with said at least one printed microactuator valve system while said appliance is operating.

10. A battery for powering an electrical appliance comprising:
at least one printed microactuator valve system having at least one rotational actuating element;
at least one aperture associated with said at least one printed microactuator valve system to admit fluid to the interior of said battery through said at least one aperture when an electrical appliance powered by said battery is turned on;
said at least one printed microactuator valve system being disposed to occlude admission of fluid to the interior of said battery through said at least one aperture associated with said at least one printed microactuator valve system while said appliance is not operating;
said at least one printed microactuator valve system having at least one rotational actuating element being disposed so that upon operation of said electrical appliance, said at least one rotational actuating element causes said at least one printed microactuator valve system to admit fluid to the interior of said battery through at least one aperture associated with said at least one printed microactuator valve system while said appliance is operating.

11. An improved electrical appliance having at least one battery comprising:
at least one printed microactuator valve system having at least one rotational actuating element;
a means for sealing operated by said at least one rotational actuating element;
at least one aperture associated with said at least one means for sealing to admit fluid to the interior of said at least one battery through said at least one aperture while said appliance is operating;
said at least one means for sealing being disposed to occlude admission of fluid to the interior of said battery through said at least one aperture associated with said at least one means for sealing while said appliance is not operating;
said at least one printed microactuator valve system having said at least one means for sealing being disposed so that upon operation of said electrical appliance, said at least one rotational actuating element causes said at least one means for sealing to admit fluid to the interior of said battery through at least one aperture associated with said at least one means for sealing while said appliance is operating.

12. The electrical appliance according to claim 11, further comprising:
said means for sealing being a moveable shutter.

13. The electrical appliance according to claim 11, further comprising:
said means for sealing being at least one diffusion layer having an oxygen diffusion enhancing material.

14. The electrical appliance according to claim 13, further comprising:
said oxygen diffusion material being on the surface of the pore structure and being selected from the group of metal, metal oxides or porous polymers having an oxide or hydroxyl molecule on the surface of the pore structure.

15. A battery for powering an electrical appliance comprising:
at least one printed microactuator valve system having at least one rotational actuating element;
a means for sealing operated by said at least one rotational actuating element;
at least one aperture associated with said at least one means for sealing to admit fluid to the interior of said battery through said at least one aperture while an electrical appliance powered by said battery is turned on;
said at least one means for sealing being disposed to occlude admission of fluid to the interior of said battery through said at least one aperture associated with said at least one means for sealing while said appliance is not operating;
said at least one printed microactuator valve system having said at least one means for sealing being disposed so that upon operation of said electrical appliance, said at least one rotational actuating element causes said at least one means for sealing to admit fluid to the interior of said battery through at least one aperture associated with said at least one means for sealing while said appliance is operating.

16. The battery according to claim 15, further comprising:
said means for sealing being a moveable shutter.

17. The battery according to claim 15, further comprising:
said means for sealing being at least one diffusion layer having an oxygen diffusion enhancing material.

18. The battery according to claim 17, further comprising:
said oxygen diffusion material being on the surface of the pore structure and being selected from the group of metal, metal oxides or porous polymers having an oxide or hydroxyl molecule on the surface of the pore structure.

19. An electrical appliance having at least one fluid depolarized battery, wherein at least one of the fluids reacts at the negative electrode of said battery, comprising:
at least one printed microactuator valve system;
at least one aperture associated with said at least one printed microactuator valve system disposed to admit fluid to the negative electrode of said at least one battery through said at least one aperture while said electrical appliance is operating;
said at least one microactuator valve system being disposed to occlude admission of fluid to the negative electrode of said at least one battery through said at least one aperture associated with said at least one printed microactuator valve system while said appliance is not operating;
said at least one printed microactuator valve system being disposed so that upon operation of said electrical appliance, said at least one printed microactuator valve system admits fluid that reacts at the negative electrode of said battery through at least one aperture associated with said at least one microactuator valve system while said appliance is operating.

20. A fluid depolarized battery for powering an electrical appliance, wherein at least one of the fluids reacts at the negative electrode of said battery, comprising:
at least one printed microactuator valve system;
at least one aperture associated with said at least one printed microactuator valve system to admit fluid to the negative electrode of said battery through said at least one aperture when an electrical appliance powered by said battery is turned on;
said at least one microactuator valve system being disposed to occlude admission of fluid to the negative electrode of said battery through said at least one aperture associated with said at least one printed microactuator valve system while said appliance is not operating;
said at least one printed microactuator valve system being disposed so that upon operation of said electrical appliance, said at least one printed microactuator valve means admits fluid that reacts at the negative electrode of said battery through at least one aperture associated with said at least one microactuator valve system while said appliance is operating.

21. The electrical appliance according to claims 1, 3, 4, 7, 9, 11, 12 and 19, further comprising:
said microactuator valve system having at least one diffusion layer having an oxygen diffusion enhancing material on the surface of the pore structure of said layer selected from the group of oxygen diffusion enhancing materials including metal, metal oxides or porous polymers having an oxide or hydroxyl molecule.

22. The electrical appliance according to claims 1, 3, 4, 7, 9, 11, 12, 13, 14 and 19, further comprising:
said electrical appliance having a means of detecting if said at least one microactuator valve system is admitting fluid, and if not, re-actuating said microactuator valve system.

23. The electrical appliance according to claims 1, 3, 4, 7, 9, 11, 12, 13, 14 and 19, further comprising:
said electrical appliance having a means of connecting a recharging system to said battery.

24. The electrical appliance according to claims 1, 3, 4, 7, 9, 11, 12, 13, 14 and 19, further comprising:
said electrical appliance having a control means having a means for delaying occlusion of the admission of fluid to said at least one battery.

25. The electrical appliance according to claims 1, 3, 4, 7, 9, 11, 12, 13, 14 and 19, further comprising:
said control means having interconnections and terminals for recharging said battery.

26. The electrical appliance according to claims 1, 3, 4, 7, 9, 11, 12, 13, 14 and 19, further comprising:
at least one of said microactuators being disposed to malfunction upon application of excess pressure inside said electrical appliance and to deform to relieve said excess pressure.

27. The electrical appliance according to claims 1, 3, 4, 7, 9, 11, 12, 13, 14 and 19, further comprising:
at least one of said microactuators being disposed to malfunction upon leakage from said battery and malfunction to prevent said battery from delivering power.

28. The electrical appliance according to claims 1, 3, 4, 7, 9, 11, 12, 13, 14 and 19, further comprising:
said electrical appliance having a power source independent of said battery for said control system.

29. The battery according to claims 2, 5, 6, 8, 10, 15, 16, 17, 18, and 20, further comprising:
said microactuator valve system having at least one diffusion layer having an oxygen diffusion enhancing material on the surface of the pore structure of said layer selected from the group of oxygen diffusion enhancing materials including metal, metal oxides or porous polymers having an oxide or hydroxyl molecule.

30. The battery according to claims 2, 5, 6, 8, 10, 15, 16, 17, 18, and 20, further comprising:
said battery having a means of connecting a recharging system to said battery.

31. The battery according to claims 2, 5, 6, 8, 10, 15, 16, 17, 18, and 20, further comprising:
said battery having a means of detecting if said at least one microactuator valve system is admitting fluid, and if not, re-actuating said microactuator valve system.

32. The battery according to claims 2, 5, 6, 8, 10, 15, 16, 17, 18, and 20, further comprising:
said battery having a control means having a means for delaying occlusion of the admission of fluid to said at least one battery.

33. The battery according to claims 2, 5, 6, 8, 10, 15, 16, 17, 18, and 20, further comprising:
said electrical appliance having a means of connecting a recharging system to said battery.

34. The battery according to claims 2, 5, 6, 8, 10, 15, 16, 17, 18, and 20, further comprising:
said control means having interconnections and terminals for recharging said battery.

35. The battery according to claims 2, 5, 6, 8, 10, 15, 16, 17, 18, and 20, further comprising:
at least one of said microactuators being disposed to malfunction upon application of excess pressure inside said electrical appliance and to deform to relieve said excess pressure.

36. The battery according to claims 2, 5, 6, 8, 10, 15, 16, 17, 18, and 20, further comprising:
at least one of said microactuators being disposed to malfunction upon leakage from said battery and malfunction to prevent said battery from delivering power.

37. A method of manufacturing an electrical appliance comprising:
printing at least one printed microactuator valve system having at least one ferromagnetic actuating element on said appliance;
excising at least one aperture associated with said at least one printed microactuator valve system to admit fluid to the interior of said at least one battery through said at least one aperture while said appliance is operating;
disposing said at least one microactuator valve system to occlude admission of fluid to the interior of said battery through said at least one aperture associated with said at least one printed microactuator valve system while said appliance is not operating;
disposing said at least one printed microactuator valve system having at least one ferromagnetic actuating element being disposed so that upon operation of said electrical appliance, said at least one ferromagnetic actuating element causes said at least one microactuator valve system to admit fluid to the interior of said battery through at least one aperture associated with said at least one microactuator valve system while said appliance is operating.

38. The electrical appliance according to claim 37, further comprising:
disposing, including by printing, control circuitry on said electrical appliance for regulating the occlusion of said aperture admitting fluid to said battery to vary from the time when the electrical appliance is being operated or not operated.

39. The electrical appliance according to claim 38, further comprising:
disposing a means for connecting to recharging apparatus on said electrical appliance.

40. A method of manufacturing a battery for operating an electrical appliance comprising:
printing at least one printed microactuator valve system having at least one ferromagnetic actuating element on said battery;
excising at least one aperture associated with said at least one printed microactuator valve system to admit fluid to the interior of said at least one battery through said at least one aperture while said appliance is operating;
disposing said at least one microactuator valve system to occlude admission of fluid to the interior of said battery through said at least one aperture associated with said at least one printed microactuator valve system while said appliance is not operating;
disposing said at least one printed microactuator valve system having at least one ferromagnetic actuating element being disposed so that upon operation of said electrical appliance, said at least one ferromagnetic actuating element causes said at least one microactuator valve system to admit fluid to the interior of said battery through at least one aperture associated with said at least one microactuator valve system while said appliance is operating.

41. The method of manufacturing a battery according to claim 41, further comprising:
disposing, including by printing, control circuitry on said battery for regulating the occlusion of said aperture admitting fluid to said battery to vary from the time when the electrical appliance is being operated or not operated.

42. The battery according to claim 42, further comprising:
disposing a means for connecting to recharging apparatus on said battery.

43. A method of manufacturing a battery for operating an electrical appliance comprising:
printing at least one printed microactuator valve system having at least one diffusion layer having an oxygen diffusion enhancing material on the surface of the pore structure of said layer selected from the group of oxygen diffusion enhancing materials including metal, metal oxides or porous polymers having an oxide or hydroxyl molecule;
excising at least one aperture associated with said at least one printed microactuator valve system to admit fluid to the interior of said at least one battery through said at least one aperture while said appliance is operating;
disposing said at least one microactuator valve system to occlude admission of fluid to the interior of said battery through said at least one aperture associated with said at least one printed microactuator valve system while said appliance is not operating;
disposing said at least one printed microactuator valve system having at least one ferromagnetic actuating element being disposed so that upon operation of said electrical appliance, said at least one ferromagnetic actuating element causes said at least one microactuator valve system to admit fluid to the interior of said battery through at least one aperture associated with said at least one microactuator valve system while said appliance is operating.

44. The method of manufacturing a battery according to claim 41, further comprising:
disposing, including by printing, control circuitry on said battery for regulating the occlusion of said aperture admitting fluid to said battery to vary from the time when the electrical appliance is being operated or not operated.

45. The battery according to claim 42, further comprising:
disposing a means for connecting to recharging apparatus on said battery.
